(19) United States
(12) Patent Application Publication
(10) Pub. No.: US 2012/0221618 A1
(43) Pub. Date: Aug. 30, 2012

(54) ENCRYPTION METHOD COMPRISING AN EXPONENTIATION OPERATION

(75) Inventors: Benoît FEIX, Aubagne (FR); Georges GAGNEROT, Marseille (FR); Myléne ROUSSELLET, Aix en Provence (FR); Vincent VERNEUIL, Aix en Provence (FR); Christophe CLAVIER, Rilhac Lastours (FR)

(73) Assignee: INSIDE SECURE, Aix-en-Provence Cedex 3 (FR)

(21) Appl. No.: 13/403,285

(22) Filed: Feb. 23, 2012

(30) Foreign Application Priority Data
Feb. 25, 2011 (FR) 11 51569

(51) Int. Cl. G06F 7/552; G06F 7/52

(52) U.S. Cl. 708/524; 708/620

(57) ABSTRACT

A method and a device protected against hidden channel attacks includes a calculation of the result of the exponentiation of a data m by an exponent d. The method and the device are configured to execute only multiplications of identical large variables, by breaking down any multiplication of different large variables x, y into a combination of multiplications of identical large variables.

### BACKGROUND OF THE INVENTION

Embodiments of the present invention relate to a method of iterative calculation of the result of the exponentiation of a data m by an exponent d, implemented in an electronic device.

Various known encryption methods are based on the modular exponentiation operation, which is mathematically expressed as follows:

m^{d} modulo(n),

where m is an input data, d an exponent, and n a module. The modular exponentiation function is a calculation of the remainder of the division by n of m at the potency d.

Such a function is used by various encryption algorithms such as the algorithm RSA (“Rivest, Shamir et Adleman”), the algorithm DSA (“Digital Signature Algorithm”), El Gamal, or the like. The data m is usually a message to be deciphered or signed and the exponent d is a private key.

It is known to execute a modular exponentiation calculation by way of the “Square & Multiply” algorithm A1 or A1′ below.

Algorithm A1′—“Square & Multiply” Exponentiation, from Left to Right

Input:
“m” and “n” integers such as m < n
“d” an exponent of v bits such as d=(dᵥ₋₁ dᵥ₋₂.... d₀)₂
Output: a=m^{d} modulo n
Step 1: a=1
Step 2: for s between v−1 and 0 perform:

| | |
|---|---|
| (Step 2A) a=(a×a) mod n | (SQUARE) |
| (Step 2B) if dₛ=1 then a=(a×m) mod n | (MULT) |

Step 3: Output result a

Algorithm A1′—“Square & Multiply” Exponentiation, from Right to Left

Input:
“m” and “n” integers such as m < n
“d” an exponent of v bits such as d=(dᵥ₋₁ dᵥ₋₂.... d₀)₂
Output: a=m^{d} modulo n
Step 1: a=1; b=m
Step 2: for s between 0 and v−1 perform:

| | |
|---|---|
| (Step 2A’) if dₛ=1 then a=(a×b) mod n | (MULT) |
| (Step 2B′) b=(b×b) mod n | (SQUARE) |

Step 3: Output result a

The algorithm A1 is called “from left to right” because the first steps of the calculation loop start by the most significant bits of the exponent, to go toward the least significant bits. The algorithm A1′ is called “from right to left” because the first steps of the calculation loop start by the least significant bits of the exponent, to go toward the most significant bits.

These algorithms include multiplications of two identical large variables and multiplications of two different large variables. It generally involves different functions to execute each of these operations, the multiplication of two identical large variables being executed by way of a square function or “SQUARE” function, while the multiplication of two different large variables is executed by way of a multiplication function or “MULT” function. This distinction is due to the fact that it is possible to calculate faster x×y when x=y than in the contrary case, by way of the SQUARE function. The ratio between the execution time of the SQUARE function and the execution time of the MULT function is generally about 0.8 but may vary between 0.5 and 1 according to the size of the considered numbers, the way the multiplication is executed, and the like.

In an electronic device of chip card type, the cryptographic calculation is generally executed by a specific processor, such as an arithmetic coprocessor or a cryptoprocessor. The calculation of “m^{d} modulo n” and more particularly the execution of the multiplications take the most calculation time of the processor in relation to the total calculation time of a signature or a ciphering or deciphering operation. The fact of alternately using the SQUARE function or the MULT function as a function of the type of calculation to be made therefore allows the global ciphering, signature or deciphering calculation time to be optimized.

However, using two different functions SQUARE and MULT leads to a leak of information which can be detected by a SPA (Single Power Analysis), i.e., by an analysis of the electrical consumption of the card. The SQUARE function having a shorter execution time than the MULT function, it is possible to differentiate the two operations by observing the electrical consumption curve of the component. “Electrical consumption” is any observable physical quantity indicating the operation of the electronic component executing the operation, in particular the electrical current consumed or the electromagnetic radiation of the component.

FIG. 1 shows a curve of electrical consumption of a component executing the algorithm A1. The consumption profile of the SQUARE and MULT functions can be clearly seen. A SQUARE operation followed by a MULT operation (Step 2A followed by a Step 2B) reveals that the bit of the exponent d is equal to 1 since the conditional branch to Step 2B requires that the condition dₛ=1 is verified. Conversely, a SQUARE operation followed by another SQUARE operation (Step 2A followed by another Step 2A) reveals that the bit of the exponent is equal to 0. The bits of the exponent d may thus be discovered the ones after the others by simply observing the electrical consumption curve.

To compensate for this drawback, Steps 2A and 2B (or 2A′ and 2B′) may be performed by way of the MULT function only, without using the SQUARE function. However, a finer analysis of the electrical consumption may make it possible to distinguish Step 2A from Step 2B (or Step 2A′ from Step 2B′) because the algorithm A1 or A1′ is not regular. Indeed, in this case, the time between two successive multiplications is not the same when the two multiplications correspond to the successive execution of two Steps 2A (bit of the exponent equal to 0) or correspond to the execution of a Step 2A followed by a Step 2B (bit of the exponent equal to 1). An attacker may thus “zoom in” on the part of the consumption curve spreading between the multiplications and may observe a time dissymmetry revealing the conditional branch and therefore the value of the bit of the exponent.

The algorithm A2 below is a version of the algorithm A1 which can compensate for this drawback. The algorithm is called “Square & Multiply Always” because a dummy multiplication using a dummy parameter b is inserted after squaring when the bit of the exponent d is equal to 0, thanks to a double conditional branch “if” and “else”.

### Algorithm A2—“Square & Multiply Always” Exponentiation

Input:
“m” and “n” integers such as m < n
“d” an exponent of v bits such as d=(dᵥ₋₁ dᵥ₋₂.... d₀)₂
Output: a=m^{d} modulo n
Step 1: a=1, b=1
Step 2: for s between v−1 and 0 perform:

| | |
|---|---|
| (Step 2A) a=(a×a) mod n | (SQUARE) |

| | |
|---|---|
| (Step 2B) if dᵥ₋ₛ=1 then a=(a×m) mod n | (MULT) |

| | |
|---|---|
| else b=(a×m) mod n | (MULT) |

Step 3: Output result a

FIG. 2 shows the electrical consumption resulting from the execution of the algorithm A2. Regularity of consumption peaks is observed, which corresponds to a succession of Steps 2A and 2B, which protects the algorithm against an attack SPA. It is therefore assumed that the double conditional branch “if” and “else” does not produce any leak which can be detected by SPA analysis, because it cannot be distinguished if the condition is true or false, since a multiplication is always executed. The algorithm A2 is called “regular” since the attacker sees a succession of identical steps. However, it does not match the atomicity principle.

The atomicity principle was introduced by B. Chevallier-Mames, M. Ciet and M. Joye, in an article entitled “Low-Cost Solutions for Preventing Simple Side-Channel Analysis: Side-Channel Atomicity”, published in IEEE Transactions on Computers, Volume 53, Issue 6 (June 2004), Pages: 760-768, 2004. It is also described in international application WO 03/083645 or U.S. Pat. No. 7,742,595.

The application of the atomicity principle leads to transform a non regular loop, for example the loop constituted by Steps 2A and 2B of the algorithm A1 or that constituted by Steps 2A′ and 2B′ of the algorithm A1′, into a regular series of multiplications, without using any dummy multiplication, for a gain of time in the execution of the algorithm.

As an example, the exponentiation algorithm A3 below, called “Multiply Always”, is the atomic version of the algorithm A1 “Square & Multiply”. The algorithm is perfectly regular in that it comprises only multiplications and in that each iteration of the main loop only includes one multiplication.

Algorithm A3—“Multiply Always”, Atomic Version, from Left to Right

Input:
“m” and “n” integers such as m < n
“d” an exponent of v bits such as d = (dᵥ₋₁ dᵥ₋₂.... d₀)₂
Output: m^{d} modulo n
Step 1: R₀ = 1, R₁ = m, s = v−1, k = 0
Step 2: as long as s ≧ 0 perform :

(Step 2A) R₀ = R₀×Rₖ mod n
(Step 2B) k = k ⊕ dₛ ; s = s − 1 + k

Step 3: Output result R₀

FIG. 3 shows the electrical consumption curve of the algorithm A3 and shows the regularity of the peaks of electrical consumption.

In this algorithm, some multiplications are multiplications of different variables and others are multiplications of identical variables. Now in the article “Distinguishing Multiplications from Squaring Operations”, Selected Areas in Cryptography, volume 5381 of Lecture Notes in Computer Science, pages 346-360, Springer, 2008, the writers F. Amiel, B. Feix, M. Tunstall, C. Whelan, and W. Marnane describe a hidden channel analysis method which uses an intrinsic difference between the multiplication of two different variables and the multiplication of two identical variables (equivalent to a squaring operation), the result of the second one having on average a Hamming weight lower than the result of the first one.

The algorithm A3 “Multiply Always” is therefore exposed to this type of attack, because it contains multiplications of different terms and multiplications of equal terms.

The algorithm A2 “Square & Multiply Always” is not sensitive to this type of attack because the multiplications executed at Step 2B are all multiplications of different variables and Step 2A is executed with the function SQUARE. It however has the drawback of a non optimized execution time due to the dummy multiplications it comprises. In addition, there is a class of attacks called “safe errors” which allow the dummy operations that an algorithm comprises to be detected. These attacks include injecting an error in a cryptographic calculation at a particular time, and observing if the calculation result is exact or wrong. This type of attack applied to the algorithm A2 makes it possible to know if a multiplication is performed after an “if” or after an “else”. Indeed, in the second case, the result of the dummy multiplication is not used for the calculation of the final result. An error injection into a loop in which the conditional branch “else” is active therefore does not affect the result and makes it possible to know that the conditional branch “else” has been retained and not the branch “if”.

It may therefore be desirable to provide a method for executing an exponentiation calculation which is protected against hidden channel attacks which have just been mentioned, and which may in addition be optimized in terms of execution speed.

### BRIEF SUMMARY OF THE INVENTION

Embodiments of the invention thus relate to an iterative calculation method protected against hidden channel attacks, for the calculation of the result of the exponentiation of a data m by an exponent d, implemented in an electronic device and including multiplications of large variables executed by way of at least one calculation block of the electronic device, including only multiplications of identical large variables, any multiplication of different large variables x, y being broken down into a combination of multiplications of identical large variables.

According to one embodiment, a multiplication of two different large variables x, y is broken down into a combination of multiplications of identical large variables by way of one of the following formulas or an equivalent formula derived from said formulas:

x×y=[(x+y)×(x+y)−x×x−y×y]/2

x×y=(x+y)×(x+y)/2−x×x/2−y×y/2

x×y=(x+y)×(x+y)/2−[x×x+y×y]/2

x×y=[(x+y)×(x+y)−x×x]/2−y×y/2

x×y=[(x+y)×(x+y)−y×y]/2−x×x/2

x×y=[(x+y)/2]×[(x+y)/2]−[(x−y)/2]×[(x−y)/2]

x×y=[(x+y)×(x+y)]/4−[(x−y)×(x−y)]/4

x×y=[(x+y)×(x+y)−(x−y)×(x−y)]/4

According to one embodiment, all the multiplications of identical large variables are executed by way of at least one calculation block for calculating the square function.

According to one embodiment, the method does not include any dummy multiplication.

According to one embodiment, the method includes simultaneously executing two multiplications of large variables by way of two calculation blocks for calculating the multiplication function or the square function.

According to one embodiment, the method includes simultaneously executing a dummy multiplication of a large variable and a non dummy multiplication of a large variable, so that a calculation block cannot be idle while the other is active.

Embodiments of the invention relate to a device protected against hidden channel attacks and configured to calculate the result of the exponentiation of a data m by an exponent d, including at least one calculation block for executing multiplications of large variables, the device being configured to execute only multiplications of identical large variables, by breaking down any multiplication of different large variables x, y into a combination of multiplications of identical large variables.

According to one embodiment, the device is configured to break down a multiplication of two different large variables x, y into a combination of multiplications of identical large variables by way of one of the following formulas or an equivalent formula derived from said formulas:

x×y=[(x+y)×(x+y)−x×x −y×y]/2

x×y=(x+y)×(x+y)/2−x×x/2−y×y/2

x×y=(x+y)×(x+y)/2−[x×x+y×y]/2

x×y=[(x+y)×(x+y)−x×x]/2−y×y/2

x×y=[(x+y)×(x+y)−y×y]/2−x×x/2

x×y=[(x+y)/2]×[(x+y)/2]−[(x−y)/2]×[(x−y)/2]

x×y=[(x+y)×(x+y)]/4−[(x−y)×(x−y)]/4

x×y=[(x+y)×(x+y)−(x−y)×(x−y)]/4

Embodiments of the invention also relate to an electronic device according to one of the embodiments described above, configured to execute all the multiplications of identical large variables by way of at least one calculation block for calculating the square function.

According to one embodiment, the electronic device is configured to execute no dummy multiplication.

According to one embodiment, the electronic device includes two calculation blocks for calculating the multiplication function or the square function, and configured to simultaneously execute two multiplications of large variables by way of the two calculation blocks.

According to one embodiment, the electronic device is configured to simultaneously execute a dummy multiplication of a large variable and a non dummy multiplication of a large variable, so that a calculation block cannot be idle while the other is active.

Embodiments of the invention also relate to an integrated circuit on semi-conductor chip, including an integrated circuit according to one of the embodiments described above.

Embodiments of the invention also relate to a portable object, including an integrated circuit according to one of the embodiments described above.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 previously described shows the curve of electrical consumption of a component executing a first conventional exponentiation algorithm,

FIG. 2 previously described shows the curve of electrical consumption of a component executing a second conventional exponentiation algorithm,

FIG. 3 previously described shows the curve of electrical consumption of a component executing a third conventional exponentiation algorithm,

FIG. 4 shows the curve of electrical consumption of a component executing an algorithm according to the invention,

FIGS. 5A, 5B show two variations of an electronic device implementing a first exponentiation algorithm according to the invention, and

FIGS. 6A, 6B show two variations of an electronic device implementing a second exponentiation algorithm according to the invention.

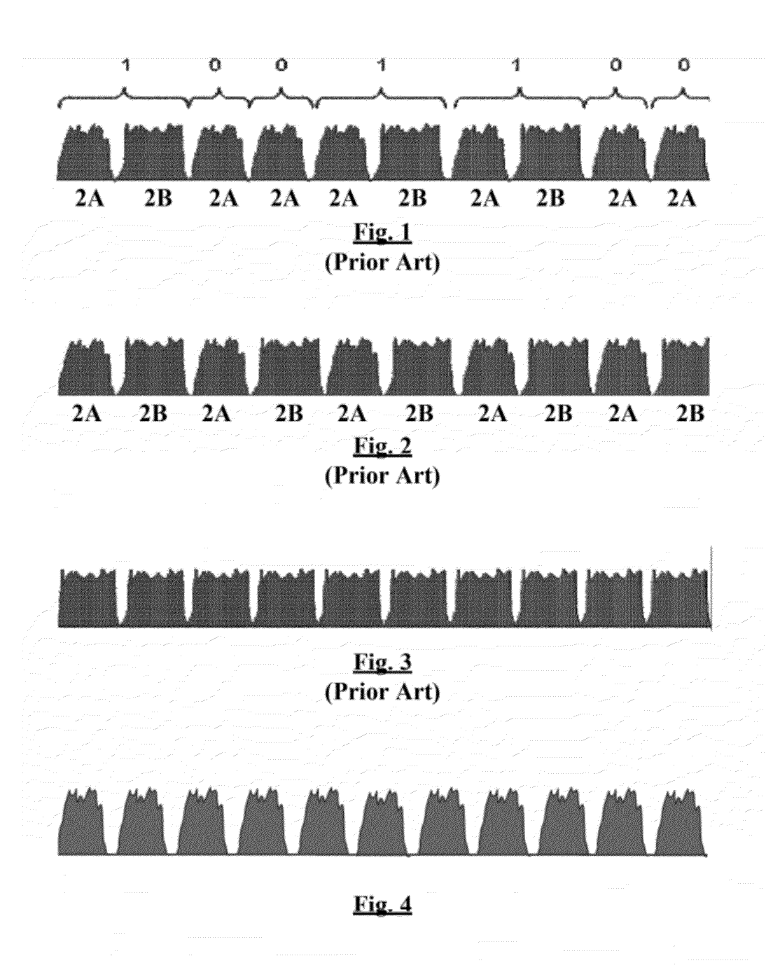

### DETAILED DESCRIPTION OF THE INVENTION

The invention relates to a cryptographic calculation method only including multiplications of identical large variables. It is based on the transformation of a multiplication of two different large variables x, y into a combination of multiplications of identical large variables, using one of the two following formulas:

(i) x×y=[(x+y)×(x+y)−x×x−y×y]/2

(ii) x×y=[(x+y)/2]×[(x+y)/2]−[(x−y)/2]×[(x−y)/2]

The implementation of the formula (i) includes the fact of replacing a call to the function MULT(a,b) by three calls to the function MULT(a,b), and executing one addition, two subtractions and one division by 2. The implementation of the formula (ii) includes the fact of replacing a call to the function MULT(a,b) by two calls to the function MULT, and executing one addition, two subtractions and two divisions by 2. These multiplications may be modular or not, according to the application considered. The method may be an exponentiation calculation RSA, a scalar multiplication in a cryptographic method ECC (Elliptic Curve Encryption), or the like.

In an embodiment variation, the calls to the function MULT(a,b) are replaced by calls to the function SQUARE(a) since these calls are always made with a=b. The function SQUARE generally being of faster execution, it allows the global execution time of the method to be optimized.

The method is thus protected against the attack described above, including distinguishing a multiplication of two different variables from a multiplication of two identical variables.

The algorithm A4 below is an examplary embodiment of an exponentiation algorithm according to the invention, from left to right, in atomic version, using the formula (i):

### Algorithm A4

Input: message “m” and module “n” such as m < n

“d” exponent of v bits such as d = (dᵥ₋₁ dᵥ₋₂ . . . d₀)₂

Output: m^{d} mod n
Step 1: R₀ = 1, R₁ = m mod n, R₂ = 1, R₃ = (m×m)/2 mod n
Step 2: u = 0, s = 2, t = 1, i = v−1
Step 3: as long as i ≧ 0 perform:

(Step 3A) Rᵤ = Rᵤ×Rᵤ mod n
(Step 3B) Rₛ = Rₛ/2 mod n
(Step 3C) if (u ≠ s) then Rₛ = Rᵤ + Rₜ mod n

else Rₛ = R₂ − Rₜ mod n

(Step 3D) s = (u + 2) mod 4, u = dᵢ*t*s, t = u + (s>>1)
(Step 3E) i = i − ((u ⊕ s) >> 1)

Step 3: Output result R₀

In the algorithm A4 and in the algorithms described below:

“a⊕b” designates the bitwise Exclusive OR of the variables a and b;

“a>>b” designates the shifting to the right of b bits of the variable a;

a*b designates the multiplication of small size variables, which is executed without calling the function MULT or the function SQUARE, i.e., without calling a multiplication or squaring block.

It is seen that Step 3A only includes multiplications of identical terms. Also, the algorithm includes no dummy multiplication. In addition, in this embodiment, the variables u, s, t and the Steps 3B to 3E are advantageously provided to regularize the operations which are executed between the multiplications at each calculation loop, not to let appear, between the executions of two multiplications, a time difference which would be a function of the value of the bit of the exponent. Indeed, although the execution time of divisions by two, of additions and subtractions is negligible, an attacker may “zoom in” on the curve of electrical consumption corresponding to these operations so as to detect hints revealing the value of the bit of the key in process.

In the algorithm A4, the formula (i) is implemented as follows: it is observed that the second operand of the multiplication of Step 2B in the algorithm A1 is constant and is worth m. This observation makes it possible to replace this multiplication of different terms by only two multiplications of identical terms and not three as required by the formula (i) in the general case. Indeed, considering the following formula (i′):

(i′)x×m=[(x+m)×(x+m)−x×x]/2−(m×m)/2

This formula makes it possible to calculate (m×m) once for all the exponentiation which renders its “cost” negligible in term of calculation time. In the algorithm A4, m is registered in R₁ and (m×m)/2 mod n is registered in R_{3.}

The algorithm being developed using specific development and simulation tools, its operation is not easy to understand simply by reading it. The operation of the algorithm may however be understood by referring to the conventional algorithm A1 as indication, and considering the execution of Steps 3A to 3E in the initial conditions defined at Step 2. Two cases may occur:
1) the bit d, of the exponent is worth 0:
   the algorithm calculates R₀=R₀×R₀ (which corresponds to Step 2A of the algorithm A1).

2) The bit dᵢ is worth 1, the algorithm performs three loops:
R₀=R₀×R₀ (which corresponds to Step 2A of the algorithm A1)
R₂=(R₀+m)×(R₀+m)/2−m×m/2, then
R₀=R₀×R₀/2 and R₀=R₂−R₀ (which corresponds to Step 2B of the algorithm A1 implemented with the formula (i′)).

FIG. 4 shows the electrical consumption profile of a component executing the algorithm A4. The electrical consumption curve only has a succession of peaks corresponding to calls to the function MULT (or SQUARE). Such a consumption curve does not allow the value of the bits of the secret exponent to be deduced and is therefore protected from an attack SPA. On the other hand, the attack including distinguishing a multiplication of two different variables from a multiplication of two identical variables cannot be applied since the method only includes multiplications of equal terms.

The algorithm A5 below is another example of exponentiation algorithm according to the invention, from left to right, in atomic version, here using the formula (ii):

### Algorithm A5

Input: message “m” and module “n” such as m < n

“d” exponent of v bits such as d = (dᵥ₋₁ dᵥ₋₂ . . . d₀)₂

Output: m^{d} mod n
Step 1: R₀ = 1, R₁ = m mod n, R₂ = 1
Step 2: u = 0, s = 2, w = 2, t = 0, i = v−1
Step 3: as long as i ≧ 0 perform:

(Step 3A) Rᵤ = Rᵤ×Rᵤ mod n
(Step 3B) if (w = 0) then R_{w} = Rₜ − R₍ₜ _{+ 1)} _{mod 3} mod n

else R_{w} = Rₜ + R₍ₜ _{+ 1)} _{mod 3} mod n

(Step 3C) Rₛ = Rₛ/2 mod n
(Step 3D) t = u, u = w*dᵢ, s = (u + 2) mod 4, w = t⊕s
(Step 3E) i = i − (w >> 1)

Step 3: Output result R₀

The algorithm A5 has an electrical consumption profile identical to the algorithm 4 and therefore offers the same degree of protection against the aforementioned attacks.

The operation of the algorithm A5 may be understood by referring to the conventional algorithm A1 described above, and considering the execution of Steps 3A to 3E in the initial conditions defined at Step 2. Two cases may occur:

1) the bit d, of the exponent is worth 0:
the algorithm calculates R₀=R₀×R₀ (which corresponds to Step 2A of the algorithm A1).

2) The bit dᵢ is worth 1, the algorithm performs three iterations of the loop “as long as”:
R₀=R₀×R₀ (which corresponds to Step 2A of the algorithm A1)
R₂=((R₀+m)/2)×((R₀+m)/2)
R₀=((R₀−m)/2)×((R₀−m)/2) and R₀=R₂−R₀ (which corresponds to Step 2B of the algorithm A1 implemented with the formula (ii)).

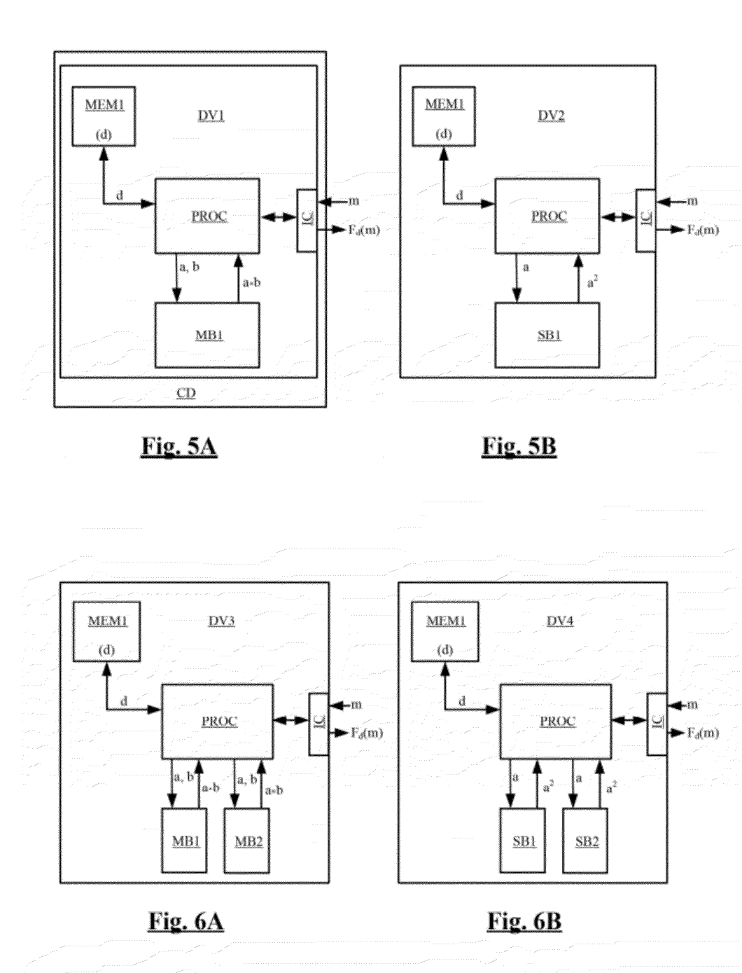

FIG. 5A shows in the form of block diagram an electronic device DV1 configured to execute a cryptographic calculation including the algorithm A4 or A5. The device DV1 may be an integrated circuit on semiconductor chip arranged on a portable support CD such as a plastic card, the whole forming a chip card.

The device DV1 includes a processor PROC, a calculation block MB1 configured to execute the function MULT(a,b) of large variables a, b, a memory MEM1 and a communication interface circuit IC. The interface circuit IC may be of the contact or contactless type, for example an interface circuit RF or UHF operating by inductive coupling or by electrical coupling. The calculation block MB1 may be a coprocessor equipped with a programmable central unit, a full hardware coprocessor of state machine type, or a multiplication sub-program executed by the processor.

In a conventional per se way, a variable is called “large” when its size (in number of bits) is higher than that of the calculation register of the processor PROC. The latter performs, without calling the calculation block MB1, multiplications of small size variables, i.e., the size of which is less than or equal to that of its calculation register, and calls the calculation block MB1 for the multiplications of large variables. For example, if the size of the calculation register is 32 bits, a large variable is a variable of more than 32 bits.

The memory MEM1 is coupled to the processor PROC and allows the device to memorize a secret key d. The processor PROC receives, through the interface circuit IC, a message to be ciphered or signed, and sends a ciphered message or a signature of the type F_{d}(m), where F is an encryption function based on the key d including an exponentiation calculation of the type m^{d} modulo(n) executed by way of the algorithm A5 or A6. During the exponentiation calculation, the processor PROC calls the calculation block MB1 by supplying thereto variables a, b which are always equal, and the calculation block MB1 outputs a×b.

FIG. 5B shows in the form of block diagram an electronic device DV2 configured to execute a cryptographic calculation including the algorithm A4 or A5. The device DV2 only differs from the device DV1 in that the calculation block MB1 is replaced by a calculation block SB1 configured to execute the function SQUARE. As previously, the calculation block SB1 may be a coprocessor equipped with a programmable central unit, a full hardware coprocessor or a squaring sub-program executed by the processor.

An exponentiation algorithm according to the invention may also derive from the algorithm A1′ described above, which constitutes the variation “from right to left” of the algorithm A1. Although in this embodiment no operand is constant during the multiplication, the formula (i) and the formula (ii) remain equivalent in term of complexity. Indeed, the formula (i) requires the calculation of three multiplications (a+b)×(a+b), a×a and b×b instead of two multiplications, but the calculation of b×b is necessary for Step 2B. Thus, these three operations allow Steps 2A and 2B to be performed. It is the same during the use of the formula (ii) which requires three multiplications: two to execute Step 2A and one to execute Step 2B.

The use of the formula (ii), which is more flexible by nature in that it generally requires two multiplications instead of three will be now considered as a non limiting example.

The algorithm A6 below is another example embodiment of an exponentiation calculation according to the invention, from right to left, in atomic version, implementing the formula (ii):

### Algorithm A6

Input: message “m” and module “n” such as m < n

“d” exponent of v bits such as d = (dᵥ₋₁ dᵥ₋₂ . . . d₀)₂

Output: m^{d} mod n
Step 1: R₀ = m mod n, R₁ = 1, R₂ = 1
Step 2: u = 2, s = 0, w = 0, t = 2, i = 0
Step 3: as long as i ≦ 1−1 perform:

(Step 3A) u = 2 −s₀ −s₁, w = 2t mod 4,

t = (2 + 2s₁) mod 3, s = 2dᵢ −w −t₀

(Step 3B) if (u = 2) then Rᵤ = R_{w} + R₁ mod n

else Rᵤ = R_{w} − R₁ mod n

(Step 3C) Rₜ = Rₜ/2 mod n
(Step 3D) Rₛ = Rₛ×Rₛ mod n
(Step 3E) i = i + 1 −s[0] −s[1]

Step 3: Output result R₁

The algorithm A6 has a consumption profile identical to the algorithm A4 or A5 and therefore offers the same degree of protection against the aforementioned attacks.

The operation of the algorithm may be understood by referring to the conventional algorithm A1 described above, and considering the execution of Steps 3A to 3E in the initial conditions defined at Step 2. Two cases may occur:

1) the bit d, of the exponent is worth 0:
the algorithm calculates R₀=R₀×R₀ (which corresponds to Step 2B of the algorithm A1′).

2) The bit dᵢ is worth 1, the algorithm performs three iterations of the loop “as long as”:
R₂=((R₀+R1)/2)×((R₀+R1)/2)
R₁=((R₀−R1)/2)×((R₀−R1)/2) and R₁=R₂−R₁ (which corresponds to Step 2A of the algorithm A1′ implemented with the formula (ii)).

R₀=R₀×R₀ (which corresponds to Step 2B of the algorithm A1′).

An exponentiation algorithm according to the invention may also be designed so as to have a parallel architecture involving two different calculation blocks and allowing two different multiplications to be simultaneously performed (or two squaring operations). Indeed, when a multiplication is replaced by two multiplications (formula (ii) or formula (i′) derived from (i)) or three multiplications (formula (i)), these multiplications are independent from one another and may therefore be executed at the same time.

In that case, particular precautions may be provided to avoid creating a leak of information which can be detected by an analysis SPA. In particular, it may be wished that an attacker cannot distinguish if one or two multiplications are executed in parallel. To that end, dummy operations may be provided.

It will be noted that the provision of dummy operations in a parallel algorithm architecture does not affect the execution time of the algorithm when the dummy operations are executed at the same time as operations necessary for the calculation of the result. Indeed, if the aim is, for example, the perfect parallelization, by way of two calculation blocks, of an algorithm including a sequence of three necessary operations O1, O2, O3, such a parallelization requires the provision of a dummy operation O4. In this case, the algorithm includes the execution in parallel, noted O1//O2, of the operations O1, O2, followed by the execution in parallel, noted O3//O4, of the operations O3, O4. Such a parallelized execution is faster than the sequential execution of O1, O2, and O3 and is also faster than the execution of O1//O2 followed by the execution of the operation O3 in isolation. It is therefore considered here that the atomicity principle is respected when dummy operations are always executed at the same time as a not dummy operation.

In addition, the algorithms from right to left are more flexible in term of parallelization. Indeed, it can be noted that the steps 2B′ of the algorithm A1′ can follow on without waiting for the result of the steps 2A′, if the intermediate results are kept in memory, whereas the steps 2A′ and 2B′ of the algorithm A1 must be executed sequentially.

The algorithm A7 below shows an example embodiment of an exponentiation calculation according to the invention, from right to left, in atomic version, implementing the formula (ii):

### Algorithm A7

Input:
“m” and “n” integers such as m < n
“d” an exponent of v bits such as d = (dᵥ₋₁ dᵥ₋₂.... d₀)₂
Output: m^{d} mod n
Step 1: a = 1 ; b = m ; extra = 0; i = 0 ; u = 1; temporary registers s₁, s₂,
s₃
Step 2: as long as i ≦ v−1 perform:

x = (a−b) mod n
y = (a+b) mod n
if dᵢ = 1 then

if extra = 0

if u = 1

s₁ = x ×x mod n // s₂ = b ×b mod n
x = (a−s₁)/4 mod n
x = s₂
x = s₃
x = 1
u = 0

else

a = y ×y mod n // s₃ = s₂ ×s₂ mod n
a = (a−s₁)/4 mod n
b = s₂
s₂ = s₃
extra = 1
u = 1

else

if true

s₁ = x ×x mod n // a = y ×y mod n
a = (a−s₁)/4 mod n
b = s₂
x = s₃
extra = 0
x = 0

else

if extra = 0

if true

b = b ×b mod n // x = y ×y mod n
x = (a−s₁)/4 mod n
x = s₂
x = s₃
x = 0
x = 0

if dᵢ₊₁ = 0 and extra = 1

b = s₂
extra = 0
i = i + 1

else

x = s₂
x = 0
x = i + 1

i = i + u

Step 3: Output result a

The notation “//” indicates two parallelized calculation steps. This atomic version of the algorithm contains dummy operations intended to hide (regularize) the handling of variables between the multiplications. These dummy operations are registered in the register x. Only the operation x=(a−b) mod n is not dummy. Likewise, dummy conditional branches are used to regularize the number of branches used by the loop.

The algorithm A8 below is an equivalent variation of the algorithm A7.

### Algorithm A8

Input:
“m” and “n” integers such as m < n
“d” an exponent of v bits such as d = (dᵥ₋₁ dᵥ₋₂.... d₀)₂
Output: m^{d} mod n
Step 1: u = 1 ; t₀ = 0 ; t₁ = 0 ; t₂ = 0 ; s₀ = 1 ; s₁ = m ; s₂ = 0 ; s₃ = 0 ;
s₄ = 0 ; s₅ = 0 ; s₆ = 0
Step 2: as long as t₀ ≦ v−1 perform:

(Step 2A) j = dₜ₀ * (v₁ + u + 1)
(Step 2B) s₅ = (R₀ − R₁) / 2 mod n
(Step 2C) s₆ = (R₀ + R₁) / 2 mod n
(Step 2D) s_{M1(j, 0)} = s_{M1(j, 1)} × s_{M1(j, 1)} mod n // s_{M1(j, 2)} =
s_{M1(j, 3)} × s_{M1(j, 3)} mod n
(Step 2E) s_{M1(j, 4)} = s₀ − s₂ mod n
(Step 2F) s_{M1(j, 5)} = s₃
(Step 2G) s_{M1(j, 6)} = s₄
(Step 2H) t₁ = M1(j, 7)
(Step 2I) u = M1(j, 8)
(Step 2J) k = 1 − (1 − dₜ₀₊₁) * t₁
(Step 2K) s_{M2(k, 0)} = s₃
(Step 2L) t_{M2(k, 1)} = 0
(Step 2M) t_{M2(k, 2)} = t_{M2(k, 2)} + 1
(Step 2N) t₀ = t₀ + u

Step 3: Output result s₀

The algorithm A8 uses two matrixes M1 and M2 registered in memory, containing constants.

$$Matrix M 1 \text{:} \begin{matrix}1 & 1 & 5 & 6 & 5 & 5 & 5 & 0 & 1 \\ 0 & 6 & 4 & 3 & 0 & 1 & 3 & 1 & 1 \\ 2 & 5 & 3 & 1 & 5 & 5 & 5 & 0 & 0 \\ 2 & 5 & 0 & 6 & 0 & 1 & 5 & 0 & 1\end{matrix}$$

$$Matrix M 2 \text{:} \begin{matrix}1 & 1 & 0 \\ 5 & 2 & 2\end{matrix}$$

The indexes of the rows and columns of M1, respectively M2, are referenced from 0 to 3, respectively from 0 to 1, for the rows, and from 0 to 8, respectively from 0 to 2, for the columns.

FIG. 6A shows in the form of block diagram an electronic device DV3 configured to execute a cryptographic calculation including the algorithm A7. The device DV3 only differs from the device DV1 in that it includes two calculation blocks MB1, MB2 of the function MULT(a,b) instead of one. The algorithm A7 having a perfectly parallel structure, the two calculation blocks are always active at the same time and there is no calculation loop in which a calculation block is active while the other block is idle.

FIG. 6B shows in the form of block diagram an electronic device DV4 configured to execute a cryptographic calculation including the algorithm A7. The device DV4 only differs from the device DV3 in that it includes two calculation blocks SB1, SB2 of the function SQUARE(a) instead of two calculation blocks of the function MULT(a,b). The two calculation blocks are always active at the same time and there is no calculation loop in which a calculation block is active while the other block is idle.

As previously, the calculation blocks MB1, MB2, SB1, SB2 may be coprocessors equipped with a programmable central unit, full hardware coprocessors or multiplication or squaring sub-programs executed by the processor.

It will be clear to those skilled in the art that the present invention is susceptible of various embodiments and applications, in particular various other forms of algorithms and encryption devices executing such algorithms.

Embodiments of the invention may in particular use formulas which are equivalent to the formulas (i) and (ii) described above, for example;

Examples of formulas equivalent to (i):

x×y=(x+y)×(x+y)/2−x×x/2−y×y/2

x×y=(x+y)×(x+y)/2−[x×x+y×y]/2

x×y=[(x+y)×(x+y)−x×x]/2−y×y/2

x×y=[(x+y)×(x+y)−y×y]/2−x×x/2

Examples of formulas equivalent to (ii):

x×y=[(x+y)×(x+y)]/4−[(x−y)×(x−y)]/4

x×y=[(x+y)×(x+y)−(x−y)×(x−y)]/4, etc.

Also, in some embodiments, the transformation of a multiplication of two different variables into two or three multiplications of identical variables by way of one of the formulas above may include a transformation of the multiplication into a plurality (i.e. more than two or three) of multiplications of identical large variables but which size is lower than that of the two different variables to be multiplied. For example in the case where the function SQUARE is used to execute multiplications of identical variables, each squaring operation may be broken into a plurality of squaring operations of variables of lower size. By using for example the Karatsuba-Ofman formulas, a multiplication of two identical variables may be replaced by 6 or 9 squaring operations which size is equal to half the size of the initial variables.

In addition, and although it has been expressly excluded before to provide, in an algorithm according to embodiments of the invention, multiplications of different large variables, some embodiments of the invention could nevertheless include such multiplications of different large variables, provided that these large variables are of dummy type, or not sensitive to hidden channel attacks. In other words, highlighting such multiplications could not give any hint allowing the bits of the exponent to be discovered. It is therefore considered, in the meaning of the invention that such multiplications do not exist since it is exclusively dealt with the protection of algorithms against hidden channel attacks.

Eventually, although the algorithms described previously have been designed to implement the atomicity principle and thus offer the best security against SPA attacks while having an optimized calculation time, non atomic embodiments of these algorithms implementing the formula (i) or (ii) are not excluded from the range of the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. An iterative calculation method protected against hidden channel attacks, for the calculation of the result of the exponentiation of a data m by an exponent d, implemented in an electronic device and comprising multiplications of large variables executed by way of at least one calculation block of the electronic device, the method comprising:
multiplications, in the electronic device, of identical large variables, any multiplication of different large variables x, y being broken down into a combination of multiplications of identical large variables.

2. The method according to claim 1, wherein a multiplication of two different large variables x, y is broken down into a combination of multiplications of identical large variables by way of one of the following formulas:
x×y=[(x+y)×(x+y)−x×x−y×y]/2
x×y=(x+y)×(x+y)/2−x×x/2−y×y/2
x×y=(x+y)×(x+y)/2−[x×x+y×y]/2
x×y=[(x+y)×(x+y)−x×x]/2−y×y/2
x×y=[(x+y)×(x+y)−y×y]/2−x×x/2
x×y=[(x+y)/2]×[(x+y)/2]−[(x−y)/2]×[(x−y)/2]
x×y=[(x+y)×(x+y)]/4−[(x−y)×(x−y)]/4
x×y=[(x+y)×(x+y)−(x−y)×(x−y)]/4.

3. The method according to claim 1, wherein all the multiplications of identical large variables are executed by way of at least one calculation block for calculating the square function.

4. The method according to claim 1, wherein the method does not include any dummy multiplication.

5. The method according to claim 1, further comprising simultaneously executing two multiplications of large variables by way of two calculation blocks for calculating the multiplication function or the square function.

6. The method according to claim 5, further comprising simultaneously executing a dummy multiplication of a large variable and a non dummy multiplication of a large variable, so that a calculation block cannot be idle while the other is active.

7. The method according to claim 1, wherein the method comprises only multiplication operations.

8. An electronic device protected against hidden channel attacks and configured to calculate the result of the exponentiation of a data m by an exponent d, the device comprising:
at least one calculation block for executing multiplications of large variables, the device being configured to execute only multiplications of identical large variables, by breaking down any multiplication of different large variables x, y into a combination of multiplications of identical large variables.

9. The electronic device according to claim 8, wherein the device is further configured to break down a multiplication of two different large variables x, y into a combination of multiplications of identical large variables by way of one of the following formulas or an equivalent formula derived from said formulas:
x×y=[(x+y)×(x+y)−x×x−y×y]/2
x×y=(x+y)×(x+y)/2−x×x/2−y×y/2
x×y=(x+y)×(x+y)/2−[x×x+y×y]/2
x×y=[(x+y)×(x+y)−x×x]/2−y×y/2
x×y=[(x+y)×(x+y)−y×y]/2−x×x/2
x×y=[(x+y)/2]×[(x+y)/2]−[(x−y)/2]×[(x−y)/2]
x×y=[(x+y)×(x+y)]/4−[(x−y)×(x−y)]/4
x×y=[(x+y)×(x+y)−(x−y)×(x−y)]/4.

10. The electronic device according to claim 8, the device being further configured to execute all the multiplications of identical large variables by way of at least one calculation block for calculating the square function.

11. The electronic device according to claim 8, wherein the device is not configured to execute a dummy multiplication.

12. The electronic device according to claim 8, comprising two calculation blocks for calculating the multiplication function or the square function, and the device being configured to simultaneously execute two multiplications of large variables by way of the two calculation blocks.

13. The electronic device according to claim 12, the device being further configured to simultaneously execute a dummy multiplication of a large variable and a non dummy multiplication of a large variable, so that one of the two calculation blocks is not idle while the other is active.

14. An integrated circuit on semiconductor chip, comprising an electronic device according to claim 8.

15. A portable object, comprising an electronic device according to claim 8.
